(19) United States
(12) Patent Application Publication
(10) Pub. No.: US 2019/0022601 A1
(43) Pub. Date: Jan. 24, 2019

(54) POROUS HOLLOW FIBER MEMBRANE, METHOD FOR PRODUCING THE SAME, AND FILTRATION METHOD

(71) Applicant: ASAHI KASEI KABUSHIKI KAISHA, Tokyo (JP)

(72) Inventor: Daisuke OKAMURA, Tokyo (JP)

(73) Assignee: ASAHI KASEI KABUSHIKI KAISHA, Tokyo (JP)

(21) Appl. No.: 16/082,356

(22) PCT Filed: Mar. 8, 2017
(86) PCT No.: PCT/JP2017/009338

§ 371 Date: Sep. 5, 2018

(30) Foreign Application Priority Data
Mar. 9, 2016 (JP) 2016-045493

(51) Int. Cl. B01D 71/34; B01D 69/08; B01D 69/02; C08J 9/26; B01D 67/00

(52) U.S. Cl. CPC B01D 71/34; B01D 69/08; C02F 1/447; C08J 9/26; B01D 67/0018; B01D 69/02

(57) ABSTRACT

A porous hollow fiber membrane includes at least a first solvent and a second solvent. The first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils. The second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils. The porous hollow fiber membrane has a three-dimensional network structure.

### TECHNICAL FIELD

The present disclosure relates to a porous hollow fiber membrane, a method for producing the porous hollow fiber membrane, and a filtration method using the porous hollow fiber membrane.

### BACKGROUND ART

Membrane filtration techniques using hollow fiber membranes to clarify liquid to be treated are being widely used in water treatment, sewage treatment, and the like. A thermally induced phase separation process is known as a method for producing hollow fiber membranes for use in the membrane filtration.

In the thermally induced phase separation process, a thermoplastic resin and an organic liquid are used. In the thermally induced phase separation process using, as the organic liquid, a solvent that does not dissolve the thermoplastic resin at room temperature and dissolves the thermoplastic resin at high temperatures, i.e., a potential solvent (poor solvent), the thermoplastic resin and the organic liquid are kneaded at a high temperature to dissolve the thermoplastic resin in the organic liquid, and then the kneaded product is cooled to room temperature to induce phase separation, and further the organic liquid is removed therefrom to produce a porous body. This process is advantageous in the following points:
(a) allowing membrane formation using a polymer, such as polyethylene, for which no appropriate solvent for dissolving the polymer at room temperature exists; and
(b) facilitating to obtain a highly strong membrane if the thermoplastic resin used is a crystalline resin, since the membrane is formed by dissolving the resin at a high temperature, and then cooling and solidifying the resin, which promotes crystallization of the resin.

Because of these advantages, the thermally induced phase separation process is frequently used in methods for producing porous membranes. With a certain type of crystalline resins, however, the membrane tends to have a spherocrystal structure, which has high strength but has low elongation and is brittle, and thus presents a durability problem in practical use.

As prior art, a technique for forming a membrane using a poor solvent for a thermoplastic resin that is selected from citric acid esters is disclosed (see Patent Literature 1).

### CITATION LIST

### Patent Literature

[PTL 1] Japanese Unexamined Patent Publication No. 2011-168741

### SUMMARY OF DISCLOSURE

### Technical Problem

However, the membrane produced according to the method disclosed. in Patent Literature 1 also has a spherocrystal structure.

In view of the above-described circumstances, the present disclosure is directed to providing a porous hollow fiber membrane having a three-dimensional network structure and having excellent chemical resistance and mechanical strength, a method for producing the porous hollow fiber membrane, and a filtration method using the porous hollow fiber membrane.

### Solution to Problem

Known techniques for producing porous hollow fiber membranes use a poor solvent in a membrane forming liquid including the thermoplastic resin to perform thermally induced phase separation. The present inventors have found through intensive study that mixing at least one non-solvent to the liquid enables producing a membrane having a three-dimensional network structure, which has excellent chemical resistance and mechanical strength, to achieve the disclosure.

The present inventors have also found that using membrane forming liquids containing a thermoplastic resin, a non-solvent, and a poor solvent enables producing a membrane having a membrane structure exhibiting a three-dimensional network structure, good pore formability, and high chemical resistance and mechanical strength. Further, the present inventors have found that performing filtration using the membrane produced as described above enables membrane filtration in a highly efficient manner.

The present disclosure provides the following inventions.

An aspect of porous hollow fiber membrane of the disclosure (which will hereinafter be referred to as a first aspect of the porous hollow fiber membrane, for convenience) is a porous hollow fiber membrane comprising a thermoplastic resin, the porous hollow fiber membrane including at least a first solvent and a second solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils;
the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils; and
the porous hollow fiber membrane has a three-dimensional network structure.

It is preferred that the first aspect of the porous hollow fiber membrane have a tensile elongation at break of 60% or more.

It is preferred that the first aspect of the porous hollow fiber membrane retain, after immersion in a 4% aqueous NaOH solution for ten days, a tensile elongation at break of 60% or more of an initial value of the tensile elongation at break.

In the first aspect of the porous hollow fiber membrane, it is preferred that the first solvent be a non-solvent that does not uniformly dissolve the thermoplastic resin in the first solvent in a first mixture of the thermoplastic resin and the first solvent even when the temperature of the first mixture is raised to the boiling point of the first solvent.

In the first aspect of the porous hollow fiber membrane, it is preferred that the second solvent be a solvent that uniformly dissolves the thermoplastic resin in the second solvent in a second mixture of the thermoplastic resin and the second solvent at a ratio of 20:80 when the second mixture is at a certain temperature that is higher than 25° C. and not higher than the boiling point of the second solvent.

The description “uniformly dissolves the thermoplastic resin in the second solvent” as used herein refers to that the solution becomes transparent without separating into two layers under visual observation.

In the first aspect of the porous hollow fiber membrane, it is more preferred that the second solvent be a poor solvent that does not uniformly dissolve the thermoplastic resin in the second solvent in the second mixture of the thermoplastic resin and the second solvent at a ratio of 20:80 when the temperature of the second mixture is 25° C., and uniformly dissolves the thermoplastic resin in the second solvent in the second mixture when the second mixture is at a certain temperature that is higher than 100° C. and not higher than the boiling point of the second solvent.

In the first aspect of the porous hollow fiber membrane, it is preferred that the thermoplastic resin be polyvinylidene fluoride.

Another aspect of the porous hollow fiber membrane of the disclosure (which will hereinafter be referred to as a second aspect of the porous hollow fiber membrane, for convenience) is a porous hollow fiber membrane comprising polyvinylidene fluoride, the porous hollow fiber membrane including a first solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a non-solvent that does not uniformly dissolve the polyvinylidene fluoride in the first solvent in a first mixture of the polyvinylidene fluoride and the first solvent at a ratio of 20:80 even when the temperature of the first mixture is raised to the boiling point of the first solvent.

It is preferred that the second aspect of the porous hollow fiber membrane comprise a second solvent that is different from the first solvent, wherein the second solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a solvent that uniformly dissolves the polyvinylidene fluoride in the second solvent in a second mixture of the polyvinylidene fluoride and the second solvent at a ratio of 20:80 when the second mixture is at a certain temperature that is higher than 25° C. and not higher than the boiling point of the second solvent.

In the second aspect of the porous hollow fiber membrane, it is more preferred that the second solvent be a poor solvent that does not uniformly dissolve the polyvinylidene fluoride in the second solvent when the temperature of the second mixture is 25° C., and uniformly dissolves the polyvinylidene fluoride in the second solvent when the second mixture is at a certain temperature that is higher than 100° C. and not higher than the boiling point of the second solvent.

The porous hollow fiber membrane of the disclosure may further comprise an inorganic material.

It is preferred that the inorganic material be at least one selected from silica, lithium chloride, and titanium oxide.

An aspect of the method for producing a porous hollow fiber membrane of the disclosure (which will hereinafter be referred to as a first aspect of the production method, for convenience) is a method for producing a porous hollow fiber membrane using a thermoplastic resin and a solvent, the solvent comprising at least a first solvent and a second solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils; and
the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-00 fatty acids, and epoxidized vegetable oils.

In the first aspect of the production method, it is preferred that the first solvent be a non-solvent that does not uniformly dissolve the thermoplastic resin in the first solvent in a first mixture of the thermoplastic resin and the first solvent at a ratio of 20:80 even when the temperature of the first mixture is raised to the boiling point of the first solvent.

In the first aspect of the production method, it is preferred that the second solvent be a poor solvent that does not uniformly dissolve the thermoplastic resin in the second solvent in a second mixture of the thermoplastic resin and the second solvent at a ratio of 20:80 when the temperature of the second mixture is 25° C., and uniformly dissolves the thermoplastic resin in the second solvent in the second mixture when the second mixture is at a certain temperature that is higher than 100° C. and not higher than the boiling point of the second solvent.

Another aspect of the method for producing a porous hollow fiber membrane of the disclosure (which will hereinafter be referred to as a second aspect of the production method, for convenience) is a method for producing a porous hollow fiber membrane comprising polyvinylidene fluoride, the method comprising:
dissolving polyvinylidene fluoride in a solvent comprising at least a first solvent and a second solvent; and
performing phase separation of the solution containing the polyvinylidene fluoride dissolved therein,
wherein the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a non-solvent that does not uniformly dissolve the polyvinylidene fluoride in the first solvent in a first mixture of the polyvinylidene fluoride and the first solvent at a ratio of 20:80 even when the temperature of the first mixture is raised to the boiling point of the first solvent, and
the second solvent is different from the first solvent, is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a solvent that uniformly dissolves the polyvinylidene fluoride in the second solvent in a second mixture of the polyvinylidene fluoride and the second solvent at a ratio of 20:80 when the second mixture is at a certain temperature that is higher than 25° C. and not higher than the boiling point of the second solvent.

In the second aspect of the production method, it is preferred that the second solvent be a poor solvent that does not uniformly dissolve the polyvinylidene fluoride in the second solvent in the second mixture of the polyvinylidene fluoride and the second solvent at a ratio of 20:80 when the temperature of the second mixture is 25° C., and uniformly dissolves the polyvinylidene fluoride in the second solvent in the second mixture when the second mixture is at a certain temperature that is higher than 100° C. and not higher than the boiling point of the second solvent.

In the second aspect of the production method, it is preferred that the phase separation be liquid-liquid phase separation.

The liquid-liquid phase separation refers to a phenomenon where the thermoplastic resin is separated into two liquid phases having different concentrations.

Yet another aspect of the method for producing a porous hollow fiber membrane of the disclosure (which will hereinafter be referred to as a third aspect of the production method, for convenience) is a method for producing a porous hollow fiber membrane comprising a thermoplastic resin, the method comprising:
dissolving the thermoplastic resin in a solvent comprising a first solvent; and
performing phase separation of the solution containing the thermoplastic resin dissolved therein,
wherein the first solvent is preferably a non-solvent that does not uniformly dissolve the thermoplastic resin in the first solvent in a first mixture of the thermoplastic resin and the first solvent at a ratio of 20:80 even when the temperature of the first mixture is raised to the boiling point of the first solvent.

In the third aspect of the production method, it is preferred that the non-solvent be at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

In the third aspect of the production method, it is preferred that the solvent further comprise a second solvent, wherein the second solvent is a solvent that uniformly dissolves the thermoplastic resin in the second solvent in a second mixture of the thermoplastic resin and the second solvent at a ratio of 20:80 when the second mixture is at a certain temperature that is higher than 25° C. and not higher than the boiling point of the second solvent.

In the third aspect of the production method, it is preferred that the second solvent be a poor solvent that does not uniformly dissolve the thermoplastic resin in the second solvent in the second mixture of the thermoplastic resin and the second solvent at a ratio of 20:80 when the temperature of the second mixture is 25° C., and uniformly dissolves the thermoplastic resin in the second solvent in the second mixture when the second mixture is at a certain temperature that is higher than 100° C. and not higher than the boiling point of the second solvent.

In the third aspect of the production method, it is preferred that the second solvent be different from the first solvent, and be at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

Still another aspect of the method for producing a porous hollow fiber membrane of the disclosure (which will hereinafter be referred to as a fourth aspect of the production method, for convenience) is a method for producing a porous hollow fiber membrane comprising a thermoplastic resin, the method comprising:
selecting a first solvent used to perform thermally induced phase separation of the thermoplastic resin;
dissolving the thermoplastic resin in a solvent comprising the selected first solvent; and
performing phase separation of the solution containing e thermoplastic resin dissolved therein,
wherein selecting the first solvent is performed based on a first criterion for determining the first solvent, wherein the first criterion is such that the thermoplastic resin is not uniformly dissolved in the first solvent in a first mixture of the thermoplastic resin and the first solvent at a ratio of 20:80 even when the temperature of the first mixture is raised to the boiling point of the first solvent.

It is preferred that the fourth aspect of the production method further comprise:
selecting a second solvent used to perform thermally induced phase separation of the thermoplastic resin,
wherein selecting the second solvent is performed based on a second criterion, wherein the second criterion is such that the thermoplastic resin is uniformly dissolved in the second solvent in a second mixture of the thermoplastic resin and the second solvent at a ratio of 20:80 when the second mixture is at a certain temperature that is higher than 25° C. and not higher than the boiling point of the second solvent.

In the fourth aspect of the production method, it is preferred that the second criterion be such that the thermoplastic resin is not uniformly dissolved in the second solvent in the second mixture of the plastic resin and the second solvent at a ratio of 20:80 when the temperature of the second mixture is 25° C., and that the thermoplastic resin is uniformly dissolved in the second solvent in the second mixture when the second mixture is at a certain temperature that is higher than 100° C. and not higher than the boiling point of the second solvent.

In the fourth aspect of the production method, it is preferred that the first solvent be at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

In the fourth aspect of the production method, it is preferred that the second solvent be different from the first solvent, and be at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

The method for producing a porous hollow fiber membrane of the disclosure may further comprise adding an inorganic material.

It is preferred that the inorganic material be at least one selected from silica, lithium chloride, and titanium oxide.

The filtration method of the disclosure comprises performing filtration using the porous hollow fiber membrane of the disclosure.

### Advantageous Effects of Disclosure

According to the present disclosure, a porous hollow fiber membrane having a membrane structure forming a three-dimensional network structure, good pore formability, and high chemical resistance and mechanical strength is provided.

### BRIEF DESCRIPTION OF THE DRAWINGS

FIG. 1 is a schematic view showing the outer surface of a porous hollow fiber membrane of one embodiment of the disclosure, and

FIG. 2 is a schematic view showing the outer surface of a porous hollow fiber membrane of a comparative example.

### DESCRIPTION OF EMBODIMENTS

Now, embodiments of the present disclosure will be described in detail. It should be noted that the disclosure is not limited to the following embodiments.

Porous Hollow Fiber Membrane

In the following description, a first aspect of the porous hollow fiber membrane and a second aspect of the porous hollow fiber membrane of the disclosure are described collectively as one embodiment.

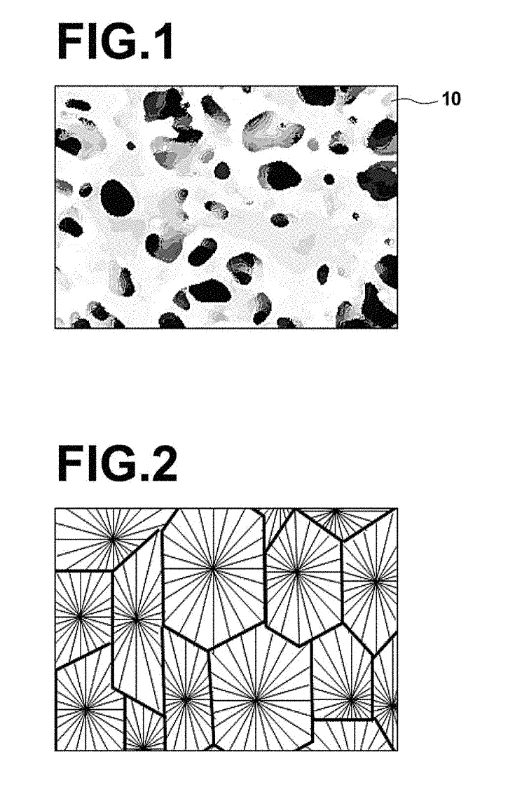

FIG. 1 schematically shows the outer surface of a porous hollow fiber membrane according to one embodiment. The outer surface of a porous hollow fiber membrane 10 shown in FIG. 1 has a three-dimensional network structure, rather than a spherocrystal structure. The three-dimensional network structure of the porous hollow fiber membrane provides higher tensile elongation at break, and higher resistance to alkali (such as an aqueous sodium hydroxide solution), or the like, often used as a clearing agent for such membranes.

The porous hollow fiber membrane 10 includes a thermoplastic resin. Examples of the thermoplastic resin may include polyolefins, copolymers of an olefin and a olefin halide, polyolefin halides, or mixtures thereof. Specific examples thereof may include polyethylene, polypropylene, polyvinyl alcohol, ethylene-vinyl alcohol copolymer, ethylene-tetrafluoroethylene copolymer, polyvinylidene fluoride (which may include a domain of hexafluoropropylene), or mixtures thereof. Since these materials are thermoplastic and thus have good handleability as well as high strength, they are excellent membrane materials. Among them, homopolymers and copolymers of vinylidene fluoride, ethylene, tetrafluoroethylene, and chlorotrifluoroethylene, or mixtures of these homopolymers and/or copolymers are preferred for their excellent mechanical strength and chemical strength (chemical resistance), as well as good formability. More specific examples include fluorine resins, such as polyvinylidene fluoride, vinylidene fluoride-hexafluoropropylene copolymer, ethylene-tetrafluoroethylene copolymer, and ethylene-chlorotrifluoroethylene copolymer.

It should be noted that the porous hollow fiber membrane 10 may contain components other than the thermoplastic resin (such as impurities) in an amount up to about 5 mass %. For example, the porous hollow fiber membrane contains a solvent that is used during production thereof. The porous hollow fiber membrane 10 contains a first solvent (which may hereinafter be referred to as non-solvent), or a second solvent (which may hereinafter be referred to as good solvent or poor solvent), or both the first solvent and the second solvent, which are used as a solvent during production, as described later. These solvents can be detected by pyrolysis GC-MS (gas chromatography mass spectrometry).

The first aspect of the porous hollow fiber membrane of the disclosure is described. The first aspect of the porous hollow fiber membrane includes a thermoplastic resin, a first solvent, and a second solvent.

Namely, the first aspect of the porous hollow fiber membrane is a porous hollow fiber membrane including a thermoplastic resin, the porous hollow fiber membrane including at least the first solvent and the second solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils,
the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and
the porous hollow fiber membrane has a three-dimensional network structure.

Examples of the C6-C30 fatty acids may include capric acid, lauric acid, oleic acid, etc.

Examples of the epoxidized vegetable oils may include epoxidized soybean oil, epoxidized linseed oil, etc.

The first solvent is preferably a non-solvent that does not uniformly dissolve the thermoplastic resin in the first solvent in a first mixture of the thermoplastic resin and the first solvent even when the temperature of the first mixture is raised to the boiling point of the first solvent.

The second solvent is preferably a solvent that uniformly dissolves the thermoplastic resin in the second solvent in a second mixture of the thermoplastic resin and the second solvent at a ratio of 20:80 when the second mixture is at a certain temperature that is higher than 25° C. and not higher than the boiling point of the second solvent.

The second solvent is more preferably a poor solvent that does not uniformly dissolve the thermoplastic resin in the second solvent in the second mixture of the thermoplastic resin and the second solvent at a ratio of 20:80 when the temperature of the second mixture is 25° C., and uniformly dissolves the thermoplastic resin in the second solvent in the second mixture when the second mixture is at a certain temperature that is higher than 100° C. and not higher than the boiling point of the second solvent.

Next, the second aspect of the porous hollow fiber membrane of the disclosure is described.

The second aspect of the porous hollow fiber membrane of the disclosure uses polyvinylidene fluoride as the thermoplastic resin, and includes at least the first solvent (non-solvent).

Namely, the second aspect of the porous hollow fiber membrane is a porous hollow fiber membrane including polyvinylidene fluoride, the porous hollow fiber membrane including the first solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a non-solvent that does not uniformly dissolve the polyvinylidene fluoride in the first solvent in a first mixture of the polyvinylidene fluoride and the first solvent at a ratio of 20:80 even when the temperature of the first mixture is raised to the boiling point of the first solvent.

The second aspect of the porous hollow fiber membrane may preferably include the second solvent that is different from the first solvent,
wherein the second solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a solvent that uniformly dissolves the polyvinylidene fluoride in the second solvent in a second mixture of the polyvinylidene fluoride and the second solvent at a ratio of 20:80 when the second mixture is at a certain temperature that is higher than 25° C. and not higher than the boiling point of the second solvent.

The second solvent more preferably is a poor solvent that does not uniformly dissolve the polyvinylidene fluoride in the second solvent when the temperature of the second mixture is 25° C., and uniformly dissolves the polyvinylidene fluoride in the second solvent when the second mixture is at a certain temperature that is higher than 100° C. and not higher than the boiling point of the second solvent.

Physical Properties of the Porous Hollow Fiber Membrane

The porous hollow fiber membrane 10 has an initial value of tensile elongation at break of preferably 60% or more, more preferably 80% or more, still more preferably 100% or more, and particularly preferably 120% or more. The tensile elongation at break can be measured using the measurement method described later in the Examples section.

Alkali resistance can be measured using values of the elongation at break before and after alkali immersion. The porous hollow fiber membrane 10 preferably retains, after immersion in a 4% aqueous NaOH solution for ten days, a tensile elongation at break of 60% or more of the initial value of the tensile elongation at break, more preferably 65% or more, and still more preferably 70% or more.

From a practical point of view, the porous hollow fiber membrane 10 has a compression strength of 0.2 MPa or more, preferably 0.3 to 1.0 MPa, and more preferably 0.4 to 1.0 MPa.

The surface of the porous hollow fiber membrane 10 has an open area ratio (surface open area ratio) of 20 to 60%, preferably 25 to 50%, and more preferably 25 to 45%. Performing filtration using the membrane that has a surface open area ratio of 20% or more on the side brought into contact with the liquid to be treated allows reducing both degradation of water permeability due to clogging and degradation of water permeability due to chafing of the membrane surface, thereby increasing stability of filtration. However, providing an excessively large pore diameter to provide a high open area ratio may hinder achieving desired separation performance. For this reason, the pore diameter at the outer surface of the membrane is 1,000 nm or less, preferably 10 to 800 nm, and more preferably 100 to 700 nm. The pore diameter being 1,000 nm or less allows blocking components to be blocked contained in the liquid to be treated, and the pore diameter being 10 nm or more allows ensuring sufficiently high water permeability.

The porous hollow fiber membrane 10 has a thickness of preferably 80 to 1,000 μm, and more preferably 100 to 300 μm. The thickness being 80 μm or more allows providing high strength, and the thickness being 1,000 μm or less allows reducing pressure loss due to membrane resistance.

The porous hollow fiber membrane 10 has a porosity of preferably 50 to 80%, and more preferably 55 to 65%. The porosity being 50% or more allows providing high water permeability, and the porosity being 80% or less allows providing high mechanical strength.

The porous hollow fiber membrane 10 may be in the form of, for example, an annular single-layer membrane, However, the porous hollow fiber membrane 10 may be in the form of a multilayer membrane including a separation layer and a support layer supporting the separation layer, which have different pore diameters from each other. The outer surface and the inner surface of the porous hollow fiber membrane 10 may have a modified cross-section structure, such as a cross-section structure including protrusions.

Liquid to be Treated

Liquids to be treated with the porous hollow fiber membrane 10 includes turbid water and process liquids. The porous hollow fiber membrane 10 is suitably used in water purification methods that include filtering turbid water.

The turbid water refers to natural water, domestic drainage, and treated water of them. Examples of the natural water include river water, lake water, groundwater, and sea water. The turbid water to be treated also includes treated water of natural water subjected to a treatment, such as sedimentation, sand filtration, coagulating-sedimentation sand filtration, ozone treatment, and activated carbon treatment. An example of the domestic drainage is sewage water. Examples of the turbid water to be treated also include primary treated water of sewage water subjected to screen filtration or sedimentation, secondary treated water of sewage water subjected to biotreatment, and even tertiary treated (highly treated) water of sewage water subjected to a treatment, such as coagulating-sedimentation sand filtration, activated carbon treatment, and ozone treatment. Such turbid water contains minute suspensoid s on the order of μm or less including organic substances, inorganic substances, and organic-inorganic mixtures (such as humic colloid, organic colloid, clay, and bacteria).

Water quality of the turbid water (the above-described natural water, domestic drainage, and treated water of them) can generally be expressed using one of or combination of turbidity and concentration of organic substances, which are representative water quality indeces. According to the turbidity (average turbidity rather than instant turbidity), the water quality can be roughly classified, for example, into low-turbidity water with a turbidity of less than 1, medium-turbidity water with a turbidity of 1 or more and less than 10, high-turbidity water with a turbidity of 10 or more and less than 50, and ultrahigh-turbidity water with a turbidity of 50 or more. According to the concentration of organic substances (Total Organic Carbon (TOC)): mg/L) (average value rather than instant value), the water quality can be roughly classified, for example, into low-TOC water with a TOC of less than 1, medium-TOC water with a TOC of 1 or more and less than 4 , high-TOC water with a TOC of 4 or more and less than 8, and ultrahigh-TOC water with a TOC of 8 or more. Basically, water with higher turbidity or TOC is more likely to cause clogging of the filtration membrane, and therefore the effect of using the porous hollow fiber membrane 10 is higher for water with higher turbidity or TOC.

The process liquid refers to a liquid to be separated in a process separating a valuable material and invaluable materials during production of food, drug, semiconductor, etc. In food production, the porous hollow fiber membrane 10 is used to separate a liquor, such as, sake or wine, from a yeast, In drug production, the porous hollow fiber membrane 10 is used, for example, for sterile filtration during purification of protein. In semiconductor production, the porous hollow fiber membrane 10 is used, for example, to separate an abrasive from water in polishing wastewater.

Method for Producing Porous Hollow Fiber Membrane 10

Next, a method for producing the porous hollow fiber membrane 10 is described. The method for producing a porous hollow fiber membrane includes (a) preparing a melt-kneaded product, (b) supplying the melt-kneaded product to a multiple-structure spinning nozzle and extruding the melt-kneaded product through the spinning nozzle to obtain a hollow fiber membrane, and (c) extracting a plasticizer from the hollow fiber membrane. If the melt-kneaded product contains an additive, the method for producing the porous hollow fiber membrane 10 includes (d) extracting the additive from the hollow fiber membrane after the step (c).

The thermoplastic resin in the melt-kneaded product has a concentration of preferably 20 to 60 mass %, more preferably 25 to 45 mass %, and even more preferably 30 to 45 mass %. The concentration being 20 mass % or more allows providing high mechanical strength, and the concentration being 60 mass % or less allows providing high water permeability. The melt-kneaded product may contain an additive.

The melt-kneaded product may consist of two components including a thermoplastic resin and a solvent, or three components including a thermoplastic resin, an additive, and a solvent. The solvent includes at least a non-solvent, as described later.

As an extracting agent used in the step (c), a liquid, such as methylene chloride or various alcohols, that does not dissolve the thermoplastic resin and has high affinity with the plasticizer is preferred.

If a melt-kneaded product that does not contain an additive is used, the hollow fiber membrane obtained after the step (c) may be used as the porous hollow fiber membrane 10. If the porous hollow fiber membrane 10 is produced using a melt-kneaded product containing an additive, the production method according to this embodiment preferably includes, after the step (c), (d) extracting the additive from the hollow fiber membrane to obtain the porous hollow fiber membrane 10. As an extracting agent used in the step (d), a liquid, such as hot water, or an acid or alkali that is capable of dissolving the additive used and does not dissolve the thermoplastic resin is preferably used.

An inorganic material may be used as the additive. The inorganic material is preferably an inorganic fine powder. The inorganic fine powder contained in the melt-kneaded product has a primary particle size of preferably 50 nm or less, and more preferably 5 nm or more and less than 30 nm. Specific examples of the inorganic fine powder include silica (including fine powder silica), titanium oxide, lithium chloride, calcium chloride, organic clay, etc. Among them, fine powder silica is preferred in view of cost. The “primary particle size” of the inorganic fine powder refers to a value that is found through analysis of an electron micrograph. Namely, first, a batch of inorganic tine powder is pre-treated according to the method prescribed in ASTM D3849. Thereafter, diameters of 3000 to 5000 particles imaged in a transmission electron micrograph are measured, and an arithmetic average of these values is calculated as the primary particle size of the inorganic fine powder.

The material of the inorganic tine powder present in the porous hollow fiber membrane can be determined by identifying elements present therein by fluorescent X-ray analysis, or the like.

If an organic substances is used as the additive, using a hydrophilic polymer, such as polyvinyl pyrrolidone or polyethylene glycol, allows imparting hydrophilicity to the hollow fiber membrane. Using an additive with high viscosity, such as glycerin, ethylene glycol, etc., allows controlling the viscosity of the melt-kneaded product.

Next, the step of (a) preparing the melt-kneaded product of the method for producing a porous hollow fiber membrane of the disclosure is described in detail.

In the method for producing a porous hollow fiber membrane of the disclosure, a non-solvent for the thermoplastic resin is mixed with a good solvent or a poor solvent. Using a non-solvent in the raw materials of the membrane allows obtaining a porous hollow fiber membrane having a three-dimensional network structure. Although the mechanism is not perfectly clear, it is believed that use of a solvent mixed with a non-solvent to reduce the solubility moderately hinders crystallization of the polymer, and this promotes formation of a three-dimensional network structure. For example, a non-solvent and a poor solvent or good solvent are selected from various esters, such as sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

Specific examples of the esters and the boiling point thereof are as follows. Acetyl tributyl citrate has a boiling point of 343° C., dibutyl sebacate has a boiling point of 345° C., dibutyl adipate has a boiling point of 305° C., di-isobutyl adipate has a boiling point of 293° C., bis(2-ethylhexyl) adipate has a boiling point of 335° C., diisononyl adipate has a boiling point of 250° C. or more, diethyl adipate has a boiling point of 251° C., triethyl citrate has a boiling point of 294° C., and triphenyl phosphite has a boiling point of 360° C.

A solvent that is capable of dissolving the thermoplastic resin at ordinary temperatures is referred to as a good solvent, a solvent that is not capable of dissolving the thermoplastic resin at ordinary temperatures but is capable of dissolving the thermoplastic resin at high temperatures is referred to as a poor solvent for the thermoplastic resin, and a solvent that is not capable of dissolving the thermoplastic resin even at high temperatures is referred to as a non-solvent. In the disclosure, the poor solvent and the non-solvent can be determined as follows.

The solvent (second solvent) is at least one selected from various esters, such as sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is one that uniformly dissolves the thermoplastic resin in the solvent in a mixture (second mixture) of the thermoplastic resin and the second solvent at a ratio of 20:80 when the second mixture is at a certain temperature that is higher than 25° C. and not higher than the boiling point of the solvent.

Further, the poor solvent (second solvent) is one that does not uniformly dissolve the thermoplastic resin in the poor solvent in the second mixture when the temperature of the second mixture is 25° C., and uniformly dissolves the thermoplastic resin in the poor solvent in the second mixture when the second mixture is at a certain temperature that is higher than 100° C. and not higher than the boiling point of the poor solvent.

The non-solvent (first solvent) is at least one selected from various esters, such as sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is one that does not uniformly dissolve the thermoplastic resin in the non-solvent (first solvent) in a mixture (first mixture) of the thermoplastic resin and the non-solvent (first solvent) at a ratio of 20:80 even when the temperature of the first mixture is raised to the boiling point of the non-solvent (first solvent).

Specifically, whether a solvent is a good solvent, a poor solvent, or a non-solvent is determined based on solubility at temperatures in the above-described ranges, which is determined by putting the thermoplastic resin in an amount of about 2 g and the solvent in an amount of about 8 g in a test tube and heating them using a test tube block heater to the boiling point of the solvent with intervals of about 10° C., and mixing then using a spatula, or the like. Namely, a solvent that dissolves the thermoplastic resin is a good solvent or poor solvent, and a solvent that does not dissolve the thermoplastic resin is a non-solvent.

For example, in the case where polyvinylidene fluoride (PVDF) is used as the thermoplastic resin, and acetyl tributyl citrate, dibutyl sebacate, or dibutyl adipate is used as the solvent, PVDF is not uniformly dissolved in the solvent at 25° C., and PVDF is uniformly mixed and dissolved in the solvent when the mixture is at a certain temperature that is raised to a temperature higher than 100° C. and not higher than the boiling point. On the other hand, in the case where bis(2-ethylhexyl) adipate, diisononyl adipate, bis(2-ethylhexyl) sebacate, or an oleic acid is used as the solvent, PVDF is not dissolved in the solvent even when the temperature is raised to the boiling point.

Further, in the case where ethylene-tetrafluoroethylene copolymer (ETFE) is used as the thermoplastic resin, and diethyl adipate is used as the solvent, ETFE is not uniformly dissolved in the solvent at 25° C., and ETFE is uniformly mixed and dissolved in the solvent when the mixture is at a certain temperature that is raised to a temperature higher than 100° C. and not higher than the boiling point. On the other hand, in the case where bis(2-ethylhexyl) adipate, diisononyl adipate, or a capric acid is used as the solvent, ETFE is not dissolved in the solvent.

Further, in the case where ethylene-monochlorotrifluoroethylene copolymer (ECTFE) is used as the thermoplastic resin, and triethyl citrate, or bis(2-ethylhexyl) adipate is used as the solvent, ECTFE is not uniformly dissolved in the solvent at 25° C., and ECTFE is uniformly dissolved in the solvent when the mixture is at a certain temperature that is raised to a temperature higher than 100° C. and not higher than the boiling point. On the other hand, in the case where triphenyl phosphite or an oleic acid is used as the solvent, ECTFE is not dissolved in the solvent.

In the case where polyethylene (PE) is used as the thermoplastic resin, and dibutyl sebacate is used as the solvent, PE is not uniformly dissolved in the solvent at 25° C., and PE is uniformly mixed and dissolved in the solvent when the mixture is at a certain temperature that is raised to a temperature higher than 100° C. and not higher than the boiling point. On the other hand, in the case where bis(2-ethylhexyl) adipate or acetyl tributyl citrate is used as the solvent, PE is not dissolved in the solvent.

Next, embodiments of the method for producing a porous hollow fiber membrane of the disclosure are described.

A first aspect of the production method of the disclosure is a method for producing a porous hollow fiber membrane comprising a thermoplastic resin and a solvent,
wherein the solvent includes at least the first solvent and the second solvent,
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and
the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

The first solvent is preferably a non-solvent, and the second solvent is preferably a poor solvent. Whether a solvent is a non-solvent or a poor solvent is determined according to the method described above.

Next, a second aspect of the production method of the disclosure is described.

The second aspect of the production method pertains to the production method where polyvinylidene fluoride is used as the thermoplastic resin.

Namely, the second aspect of the production method of the disclosure includes:
dissolving polyvinylidene fluoride in a solvent comprising at least a first solvent and a second solvent; and
performing phase separation of the solution containing the polyvinylidene fluoride dissolved therein,
wherein the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a non-solvent that does not uniformly dissolve the polyvinylidene fluoride in the first solvent in a first mixture of the polyvinylidene fluoride and the first solvent at a ratio of 20:80 even when the temperature of the first mixture is raised to the boiling point of the first solvent, and
the second solvent is different from the first solvent, is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a solvent that uniformly dissolves the polyvinylidene fluoride in the second solvent in a second mixture of the polyvinylidene fluoride and the second solvent at a ratio of 20:80 when the second mixture is at a certain temperature that is higher than 25° C. and not higher than the boiling point of the second solvent.

In the second aspect of the production method, the second solvent may be a poor solvent that does not uniformly dissolve the polyvinylidene fluoride in the solvent in the second mixture when the temperature of the second mixture is 25° C., and uniformly dissolves the polyvinylidene fluoride in the second solvent when the second mixture is at a certain temperature that is higher than 100° C. and not higher than the boiling point of the second solvent.

The phase separation is preferably liquid-liquid phase separation. The liquid-liquid phase separation may be thermally induced phase separation.

A third aspect of the production method of the disclosure uses a solution containing at least a non-solvent in the step of (a) preparing a melt-kneaded product of the method for producing a porous hollow fiber membrane.

Namely, the third aspect of the production method of the disclosure includes:
dissolving a thermoplastic resin in a solvent comprising a first solvent; and
performing phase separation of the solution containing the thermoplastic resin dissolved therein,
wherein first solvent is preferably a non-solvent that does not uniformly dissolve the thermoplastic resin in the first solvent in a first mixture of the thermoplastic resin and the first solvent even when the temperature of the first mixture is raised to the boiling point of the first solvent.

As the non-solvent, the esters, and the like, listed as the second solvent in the above-described second aspect of the production method can be used.

Further, the solvent may contain a solvent or a poor solvent (the second solvent), and the esters, and the like, listed as the second solvent in the above-described second aspect of the production method can be used.

Next, a fourth aspect of the production method of the disclosure is described.

The fourth aspect of the production method pertains to a method for selecting a non-solvent according to a first criterion, and selecting a solvent or a poor solvent according to a second criterion, in the step of (a) preparing a melt-kneaded product of the method for producing a porous hollow fiber membrane.

Namely, the fourth aspect of the production method of the disclosure includes:
selecting a first solvent used to perform thermally induced phase separation of a thermoplastic resin;
dissolving the thermoplastic resin in a solvent including the selected first solvent; and
performing phase separation of the solution containing the thermoplastic resin dissolved therein,
wherein selecting the first solvent is performed based on a first criterion for determining the first solvent, wherein the first criterion is such that the thermoplastic resin is not uniformly dissolved in the first solvent in a first mixture of the thermoplastic resin and the first solvent at a ratio of 20:80 even when the temperature of the first mixture is raised to the boiling point of the first solvent.

It is preferred that the fourth aspect of the production method of the disclosure further include selecting a second solvent used to perform thermally induced phase separation of the thermoplastic resin,
wherein selecting the second solvent is performed based on a second criterion, wherein the second criterion is such that the thermoplastic resin is uniformly dissolved in the second solvent in a second mixture of the thermoplastic resin and the second solvent at a ratio of 20:80 when the second mixture is at a certain temperature that is higher than 25° C. and not higher than the boiling point of the second solvent.

The second criterion is preferably such that the thermoplastic resin is not uniformly dissolved in the second solvent in the second mixture of the plastic resin and the second solvent at a ratio of 20:80 when the temperature of the second mixture is 25° C., and that the thermoplastic resin is uniformly dissolved in the second solvent when the second mixture is at a certain temperature that is higher than 100° C. and not higher than the boiling point of the second solvent.

The first solvent is preferably at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

It is preferred that the second solvent be different from the first solvent, and be at least one selected from sebacic acid esters, citric acid esters, acetyl citric acid esters, adipic acid esters, trimellitic acid esters, oleic acid esters, palmitic acid esters, stearic acid esters, phosphoric acid esters, C5-C30 fatty acids, and epoxidized vegetable oils.

Filtration Method

The filtration method of the disclosure includes performing filtration of the liquid to be treated using the porous hollow fiber membrane of the disclosure. Using the porous hollow fiber membrane of the disclosure enables performing the filtration in a highly efficient manner.

### EXAMPLES

Now, the present disclosure is described in detail with reference to examples, which are not intended to limit the disclosure. Values of physical properties of examples and comparative example were found according to the following methods.

(1) Outer Diameter and Inner Diameter of Membrane

Each hollow fiber membrane was cut into thin slices with a razor, and the outer diameter and the inner diameter thereof were measured using a 100× magnifying glass. For each sample, measurement was performed at 60 points at 30-mm intervals. At this time, the standard deviation and the average value were calculated, and then a value of (Standard deviation)/(Average value) was calculated as the variation coefficient.

(2) Observation of Porosity, Pore Diameter, and Membrane Structure

Using an electron microscope, SU8000 series, available from HITACHI, 5000× electron microscope (SEM) images of the surface and a cross section of each hollow fiber membrane were taken with an accelerating voltage of 3 kV. The electron microscope sample of the cross section was obtained by slicing a membrane sample that was frozen in ethanol. Then, using an image analysis software, Winroof6.1.3, “noise removal” of the SEM images was performed at a value “6”, and then, binarizaion with a single threshold value, “threshold value:105”, was performed. The open area ratio at the membrane surface was found by finding areas occupied by pores on the thus obtained binarized images.

The pore diameter was determined by adding pore areas of individual pores present on the surface in the ascending order of pore diameter, and determining the pore diameter of the pore whose pore area was added just before 50% of the total pore area was reached.

The membrane structure was determined by observing the membrane surface and the cross section captured in the 5000× images, where a membrane that had no spherocrystals and had polymer trunks exhibiting a three-dimensional network structure was determined as having a three-dimensional network structure.

(3) Water Permeability

Each hollow fiber membrane having a length of about 10 cm was immersed in ethanol, and then immersed in pure water several times. Thereafter, one end of the wet hollow fiber membrane was sealed, and a syringe needle was inserted into the hollow portion of the membrane through the other end to inject pure water at 25° C. into the hollow portion from the syringe needle at a pressure of 0.1 MPa, under an environment of 25° C. Then, the amount of pure water permeated to the outer surface was measured, and pure water flux was determined according to the equation below to evaluate the water permeability.

Pure water flux [L/m²/h]=60×(Amount of permeated water [L])/{π×(Outer diameter of membrane [m])×(Effective membrane length [m])×(Measurement time [min])}

It should be noted that the effective membrane length here refers to a net length of the membrane excluding the length of the portion in which the syringe needle is inserted.

(4) Tensile Elongation at Break (%)

Load and displacement at tensile break were measured using each hollow fiber membrane as a sample according to the method prescribed in JIS K7161 under the following conditions.
Measuring instrument: Instron-type tensile tester (AGS-5D, available from Shimadzu Corporation)
Distance between chucks: 5 cm
Tensile speed: 20 cm/minute

The tensile elongation at break was calculated from the obtained results according to JIS K7161.

(5) Water Permeability Retention During Filtration of Turbid Water

This is an index used to determine the degree of degradation of water permeability due to clogging (fouling). Each wet hollow fiber membrane, after immersed in ethanol, and then immersed in pure water several times, with an effective membrane length of 11 cm was used to perform filtration according to the external pressure method. First, pure water was filtered under such a filtration pressure that the pure water permeated at a rate of 10 m³ per day per 1 m² of the outer surface area of the membrane, and the permeated water was collected for 2 minutes. The resulting value was used as an initial pure water permeability. Subsequently, surface stream water of a river (Fujikawa River surface stream water with a turbidity of 2.2 and a TOC concentration of 0.8 ppm), which is natural turbid water, was filtered for 10 minutes under the same filtration pressure as that in the measurement of the initial pure water permeability, and the permeated water was collected for the last 2 minutes of the filtration. The resulting value was used as a turbid water filtration permeability. The water permeability retention during filtration of turbid water is defined as the equation below. All the operations were performed at 25° C., and a linear velocity at membrane surface of 0.5 in/second.

Water permeability retention during filtration of turbid water [%]=100×(Turbid water filtration permeability [g])/(Initial pure water permeability [g])

The individual parameters above equation are calculated as follows.

Filtration pressure={(Input pressure)+(Output pressure)}/2

Outer surface area of membrane [m²]=π×(Outer diameter of fiber [m])×(Effective membrane length [m])

Linear velocity at membrane surface [m/s]=4×(Amount of circulated water [m³/s])/{π×(Tube diameter [m])²−π×(Outer diameter of membrane [m])²}

During this measurement, the filtration pressure for the turbid water was set such that the filtration pressure was not uniform across the membranes, and that the initial pure water permeability (which is the same as the water permeability at the start of filtration of turbid water) was at a rate of 10 m³ per day per 1 m² of the outer surface area of the membrane. This is because that, in an actual water treatment or sewage water treatment, membranes are usually used in a constant rate filtration operation (where the filtration pressure is adjusted such that a fixed amount of filtered water is obtained within a fixed amount of time), and it was contemplated t© allow, in this measurement using a single hollow fiber membrane, comparison of the water permeability degradation under conditions as near as possible to the conditions of the constant rate filtration operation.

(6) Chemical Resistance Test

Each wetted porous hollow fiber membrane was cut to a length of 10 cm, and 20 pieces of them were immersed in 500 ml of a 4% aqueous sodium hydroxide solution for ten days and kept at 40° C. Tensile elongation at break of the membrane before and after the immersion in sodium hydroxide was measured for the 20 samples, and the average value was calculated. An elongation retention, which is defined as 100×(Elongation after immersion)/(Elongation before immersion), was used to evaluate chemical resistance.

### Example 1

A melt-kneaded product was extruded using a spinning nozzle having a double tube structure to obtain a porous hollow fiber membrane of Example 1.

The melt-kneaded product was prepared using 40 mass % of PVDF resin (KF-W#1000, available from Kureha Corpolation) as the thermoplastic resin, 23 mass % of fine powder silica (primary particle size: 16 nm), and 32.9 mass % of bis(2-ethylhexyl) adipate (DOA, boiling point 335° C.) and 4.1 mass % of acetyl tributyl citrate (ATBC, boiling point 343° C.) as the solvent, The temperature of the melt-kneaded product was about 200° C. to 250° C.

The hollow fiber extrudate passed through a free running distance of 120 mm was then solidified in water at 30° C. to produce a porous hollow fiber membrane by the thermally induced phase separation process. The hollow fiber extrudate was taken up on a reel at a speed of 5 m/minute. The thus obtained double layer hollow fiber extrudate was immersed in isopropyl alcohol to extract and remove the bis(2-ethylhexyl) adipate and the acetyl tributyl citrate. Subsequently, the hollow fiber membrane was immersed in water for 30 minutes for water substitution. Then, the hollow fiber membrane was immersed in a 20 mass % aqueous NaOH solution at 70° C. for one hour, and repeatedly washed with water to extract and remove the fine powder silica.

The formulation, production conditions, and various performances of the obtained porous hollow fiber membrane of Example 1 are shown in Table 1. The membrane structure of this porous hollow fiber membrane exhibited a three-dimensional network structure, such as one shown in FIG. 1.

### Example 2

A porous hollow fiber membrane was produced in the same manner as in Example 1, except that the melt-kneaded product was prepared using 4.1 mass % of dibutyl sebacate (DBS, boiling point 345° C.) as the solvent in place of 4.1 mass % of acetyl tributyl citrate (ATBC, boiling point 343° C.).

The formulation, production conditions, and various performances of the obtained porous hollow fiber membrane of Example 2 are shown in Table 1. The membrane structure of this porous hollow fiber membrane exhibited a three-dimensional network structure, such as one shown in FIG. 1.

### Example 3

A porous hollow fiber membrane was produced in the same manner as in Example 1, except that the melt-kneaded product was prepared using 32.9 mass % of diisononyl adipate (DINA, boiling point 250° C. or more) as the solvent in place of 32.9 mass % of bis(2-ethylhexyl) adipate (DOA, boiling point 335° C.).

The formulation, production conditions, and various performances of the obtained porous hollow fiber membrane of Example 3 are shown in Table 1. The membrane structure of this porous hollow fiber membrane exhibited a three-dimensional network structure, such as one shown in FIG. 1.

### Example 4

A porous hollow fiber membrane was produced in the same manner as in Example 1, except that the melt-kneaded product was prepared using 40 mass % of ETFE resin (TL-081, available from Asahi Glass Co., Ltd.) as the thermoplastic resin, 23 mass % of fine powder silica (primary particle size: 16 nm), and 32.9 mass % of bis(2-ethylhexyl) adipate (DOA, boiling point 335° C.) and 4.1 mass % of di-isobutyl adipate (DIBA, boiling point 293° C.) as the solvent.

The formulation, production conditions, and various performances of the obtained porous hollow fiber membrane of Example 4 are shown in Table 1. The membrane structure of this porous hollow fiber membrane exhibited a three-dimensional network structure, such as one shown in FIG. 1.

### Example 5

A porous hollow fiber membrane was produced in the same manner as in Example 1, except that the melt-kneaded product was prepared using 40 mass % of ECTFE resin (HALAR901, available from Solvay Specialty Polymers) as the thermoplastic resin, 23 mass % of fine powder silica (primary particle size: 16 nm), and 32.9 mass % of triphenyl phosphite (TPP, boiling point 360° C.) and 4.1 mass % of bis(2-ethylhexyl) adipate (DOA, boiling point 335° C.) as the solvent.

The formulation, production conditions, and various performances of the obtained porous hollow fiber membrane of Example 5 are shown in Table 1. The membrane structure of this porous hollow fiber membrane exhibited a three-dimensional network structure, such as one shown in FIG. 1.

### Example 6

A porous hollow fiber membrane was produced in the same manner as in Example 1, except that the melt-kneaded product was prepared using 40 mass % of ETFE resin (TL-081, available from Asahi Glass Co., Ltd.) as the thermoplastic, and 30 mass % of bis(2-ethylhexyl) adipate (DOA, boiling point 335° C.) and 30 mass % of di-isobutyl adipate (DIBA, boiling point 293° C.) as the solvent, and without using the fine powder silica.

The hollow fiber extrudate passed through a free running distance of 120 mm was then solidified in water at 30° C. to produce a porous hollow fiber membrane by the thermally induced phase separation process. The hollow fiber extrudate was taken up on a reel at a speed of 5 m/minute. The thus obtained double layer hollow fiber extrudate was immersed in isopropyl alcohol to extract and remove the solvent.

The formulation, production conditions, and various performances of the obtained porous hollow fiber membrane of Example 6 are shown in Table 1. The membrane structure of this porous hollow fiber membrane exhibited a three-dimensional network structure, such as one shown in FIG. 1.

### Comparative Example 1

A hollow fiber membrane of Comparative Example 1 was obtained in the same manner as in Example 1 except that only ATBC was used as the solvent. The formulation, production conditions, and various performances of the obtained porous hollow fiber membrane of Comparative Example 1 are shown in Table 1. The membrane structure of this porous hollow fiber membrane exhibited a spherocrystal structure, such as one shown in FIG. 2.

### Comparative Example 2

A porous hollow fiber membrane of Comparative Example 2 was obtained in the same manner as in Example 6, except that only DIBA was used as the solvent, and the fine powder silica was not used. The formulation, production conditions, and various performances of the obtained porous hollow fiber membrane of Comparative Example 2 are shown in Table 1. The membrane structure of this porous hollow fiber membrane exhibited a spherocrystal structure, such as one shown in FIG. 2.

### Comparative Example 3

A hollow fiber membrane of Comparative Example 3 was obtained in the same manner as in Example 5, except that only DOA was used as the solvent. The formulation, production conditions, and various performances of the obtained porous hollow fiber membrane of Comparative Example 2 are shown in Table 1. The membrane structure of this porous hollow fiber membrane exhibited a spherocrystal structure, such as one shown in FIG. 2.

TABLE 1

| | Example 1 | Example 2 | Example 3 | Example 4 | Example 5 | Example 6 |
|---|---|---|---|---|---|---|
| Resin | PVDF KF | PVDF KF | PVDF KF | ETFE | ECTFE | ETFE |
| | W#1000 | W#1000 | W#1000 | TL-081 | Halar901 | TL-081 |
| | 40 mass % | 40 mass % | 40 mass % | 40 mass % | 40 mass % | 40 mass % |
| Additive | fine powder | fine powder | fine powder | fine powder | fine powder | none |
| | silica | silica | silica | silica | silica | |
| | 23 mass % | 23 mass % | 23 mass % | 23 mass % | 23 mass % | |
| Non-solvent | DOA | DOA | DINA | DOA | TPP | DOA |
| | 32.9 mass % | 32.9 mass % | 32.9 mass % | 32.9 mass % | 32.9 mass % | 30 mass % |
| Poor solvent | ATBC | DBS | ATBC | DIBA | DOA | DIBA |
| | 4.1 mass % | 4.1 mass % | 4.1 mass % | 4.1 mass % | 4.1 mass % | 30 mass % |
| Membrane forming liquid temperature [° C.] | 240 | 240 | 240 | 250 | 240 | 250 |
| Solidification liquid | water | water | water | water | water | water |
| Solidification liquid temperature [° C.] | 30 | 30 | 30 | 30 | 30 | 30 |
| Free running distance [mm] | 120 | 120 | 120 | 120 | 120 | 120 |
| Pore diameter [nm] | 200 | 200 | 250 | 200 | 200 | 200 |
| Pore structure | three- | three- | three- | three- | three- | three- |
| | dimensional | dimensional | dimensional | dimensional | dimensional | dimensional |
| | network | network | network | network | network | network |
| Surface open area ratio [%] | 30 | 30 | 30 | 25 | 25 | 25 |
| Water permeability [L/(m² · h)] | 2,000 | 1,800 | 3,000 | 2,500 | 2,000 | 2,000 |
| Outer diameter/inner diameter [mm] | 1.2/0.7 | 1.2/0.7 | 1.2/0.7 | 1.2/0.7 | 1.2/0.7 | 1.2/0.7 |
| Tensile elongation at break [%] | 170 | 160 | 150 | 160 | 120 | 160 |
| Elongation retention after immersion in | 70 | 70 | 70 | 90 | 90 | 90 |
| NaOH [%] | | | | | | |
| Water permeability retention [%] | 75 | 75 | 75 | 70 | 80 | 70 |

TABLE 2

| | Comparative | Comparative | Comparative |
|---|---|---|---|
| | Example 1 | Example 2 | Example 3 |
| Resin | PVDF KF W#1000 | ETFE TL-081 | ECTFE HALAR901 |
| | 40 mass % | 40 mass % | 40 mass % |
| Additive | fine powder silica | none | fine powder silica |
| | 23 mass % | | 23 mass % |
| Non-solvent | none | none | none |
| Poor solvent | ATBC | DIBA | DOA |
| | 37 mass % | 60 mass % | 37 mass % |
| Membrane forming liquid ejection | 240 | 250 | 240 |
| temperature [° C.] | | | |
| Solidification liquid | water | water | water |
| Solidification liquid temperature [° C.] | 30 | 30 | 30 |
| Free running distance [mm] | 120 | 120 | 120 |
| Pore diameter [nm] | 200 | 100 | 100 |
| Pore structure | spherocrystal | spherocrystal | spherocrystal |
| Surface open area ratio [%] | 15 | 15 | 15 |
| Water permeability [L/(m² · h)] | 150 | 200 | 100 |
| Outer diameter/inner diameter [mm] | 1.2/0.7 | 1.2/0.7 | 1.2/0.7 |
| Tensile elongation at break [%] | 30 | 100 | 30 |
| Elongation retention after immersion in | 30 | 80 | 80 |
| NaOH [%] | | | |
| Water permeability retention [%] | 30 | 30 | 30 |

As shown in Tables 1 and 2, Examples 1 to 6 demonstrated that including a non-solvent in the membrane forming liquid in the membrane formation using the thermally induced phase separation allows providing a porous hollow fiber membrane having good pore formability, and high chemical resistance and mechanical strength.

On the other hand, Comparative Examples 1 to 3, which did not include a non-solvent, exhibited a spherocrystal pore structure, and poorer pore formability, chemical resistance, and mechanical strength.

### INDUSTRIAL APPLICABILITY

According to the present disclosure, a porous hollow fiber membrane is formed using a non-solvent, and this provides a porous hollow fiber membrane having good pore formability, and high chemical resistance and mechanical strength.

1. A porous hollow fiber membrane comprising a thermoplastic resin, the porous hollow fiber membrane including at least a first solvent and a second solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils;
the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils; and
the porous hollow fiber membrane has a three-dimensional network structure.

2. The porous hollow fiber membrane as claimed in claim 1, wherein the porous hollow fiber membrane has a tensile elongation at break of 60% or more.

3. The porous hollow fiber membrane as claimed in claim 1, wherein the porous hollow fiber membrane retains, after immersion in a 4% aqueous NaOH solution for ten days, a tensile elongation at break of 60% or more of an initial value of the tensile elongation at break.

4. The porous hollow fiber membrane as claimed in claim 1, wherein the first solvent is a non-solvent that does not uniformly dissolve the thermoplastic resin in the first solvent in a first mixture of the thermoplastic resin and the first solvent at a ratio of 20:80 even when the temperature of the first mixture is raised to the boiling point of the first solvent.

5. The porous hollow fiber membrane as claimed in claim 1, wherein the second solvent is a solvent that uniformly dissolves the thermoplastic resin in the second solvent in a second mixture of the thermoplastic resin and the second solvent at a ratio of 20:80 when the second mixture is at a certain temperature that is higher than 25° C. and not higher than the boiling point of the second solvent.

6. The porous hollow fiber membrane as claimed in claim 5, wherein the second solvent is a poor solvent that does not uniformly dissolve the thermoplastic resin in the second solvent in the second mixture of the thermoplastic resin and the second solvent at a ratio of 20:80 when the temperature of the second mixture is 25° C., and uniformly dissolves the thermoplastic resin in the second solvent in the second mixture when the second mixture is at a certain temperature that is higher than 100° C. and not higher than the boiling point of the second solvent.

7. The porous hollow fiber membrane as claimed in claim 1, wherein the thermoplastic resin is polyvinylidene fluoride.

8. A porous hollow fiber membrane comprising polyvinylidene fluoride, porous hollow fiber membrane including a first solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a non-solvent that does not uniformly dissolve the polyvinylidene fluoride in the first solvent in a first mixture of the polyvinylidene fluoride and the first solvent at a ratio of 20:80 even when the temperature of the first mixture is raised to the boiling point of the first solvent.

9. The porous hollow fiber membrane as claimed in claim 8, wherein
the porous hollow fiber membrane comprises a second solvent that is different from the first solvent, wherein the second solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a solvent that uniformly dissolves the polyvinylidene fluoride in the second solvent in a second mixture of the polyvinylidene fluoride and the second solvent at a ratio of 20:80 when the second mixture is at a certain temperature that is higher than 25° C. and not higher than the boiling point of the second solvent.

10. The porous hollow fiber membrane as claimed in claim 9, wherein the second solvent is a poor solvent that does not uniformly dissolve the polyvinylidene fluoride in the second solvent when the temperature of the second mixture is 25° C., and uniformly dissolves the polyvinylidene fluoride in the second solvent when the second mixture is at a certain temperature that is higher than 100° C. and not higher than the boiling point of the second solvent.

11. The porous hollow fiber membrane as claimed in claim 1, further comprising an inorganic material.

12. The porous hollow fiber membrane as claimed in claim 11, wherein the inorganic material is at least one selected from silica, lithium chloride, and titanium oxide.

13. A method for producing a porous hollow fiber membrane using a thermoplastic resin and a solvent, the solvent comprising at least a first solvent and a second solvent, wherein:
the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils; and
the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

14. The method for producing a porous hollow fiber membrane as claimed in claim 13, wherein the first solvent is a non-solvent that does not uniformly dissolve the thermoplastic resin in the first solvent in a first mixture of the thermoplastic resin and the first solvent at a ratio of 20:80 even when the temperature of the first mixture is raised to the boiling point of the first solvent.

15. The method for producing a porous hollow fiber membrane as claimed in claim 13, wherein the second solvent is a poor solvent that does not uniformly dissolve the thermoplastic resin in the second solvent in the second mixture of the thermoplastic resin and the second solvent at a ratio of 20:80 when the temperature of the second mixture is 25° C., and uniformly dissolves the thermoplastic resin in the second solvent in the second mixture when the second mixture is higher than 100° C. and not higher than the boiling point of the second solvent.

16. A method for producing a porous hollow fiber membrane comprising polyvinylidene fluoride, the method comprising:
dissolving polyvinylidene fluoride in a solvent comprising at least a first solvent and a second solvent; and
performing phase separation of the solution containing the polyvinylidene fluoride dissolved therein,
wherein the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a non-solvent that does not uniformly dissolve the polyvinylidene fluoride in the first solvent in a first mixture of the polyvinylidene fluoride and the first solvent at a ratio of 20:80 even when the temperature of the first mixture is raised to the boiling point of the first solvent, and
the second solvent is different from the first solvent, is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils, and is a solvent that uniformly dissolves the polyvinylidene fluoride in the second solvent in a second mixture of the polyvinylidene fluoride and the second solvent at a ratio of 20:80 when the second mixture is at a certain temperature that is higher than 25° C. and not higher than the boiling point of the second solvent.

17. The method for producing a porous hollow fiber membrane as claimed in claim 16, wherein the second solvent is a poor solvent that does not uniformly dissolve the polyvinylidene fluoride in the second solvent in the second mixture of the polyvinylidene fluoride and the second solvent at a ratio of 20:80 when the temperature of the second mixture is 25° C., and uniformly dissolves the polyvinylidene fluoride in the second solvent in the second mixture when the second mixture is at a certain temperature that is higher than 100° C. and not higher than the boiling point of the second solvent.

18. The method for producing a porous hollow fiber membrane as claimed in claim 16, wherein the phase separation is liquid-liquid phase separation.

19. A method for producing a porous hollow fiber membrane comprising a thermoplastic resin, the method comprising:
dissolving the thermoplastic resin in a solvent comprising a first solvent; and
performing phase separation of the solution containing the thermoplastic resin dissolved therein,
wherein the first solvent is a non-solvent that does not uniformly dissolve the thermoplastic resin in the first solvent in a first mixture of the thermoplastic resin and the first solvent at a ratio of 20:80 even when the temperature of the first mixture is raised to the boiling point of the first solvent.

20. The method for producing a porous hollow fiber membrane as claimed in claim 19, wherein the non-solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

21. The method for producing a porous hollow fiber membrane as claimed in claim 17, wherein the solvent further comprises a second solvent, wherein the second solvent is a solvent that uniformly dissolves the thermoplastic resin in the second solvent in a second mixture of the thermoplastic resin and the second solvent at a ratio of 20:80 when the second mixture is at a certain temperature that is higher than 25° C. and not higher than the boiling point of the second solvent.

22. The method for producing a porous hollow fiber membrane as claimed in claim 21, wherein the second solvent is a poor solvent that does not uniformly dissolve the thermoplastic resin in the second solvent in the second mixture of the thermoplastic resin and the second solvent at a ratio of 20:80 when the temperature of the second mixture is 25° C., and uniformly dissolves the thermoplastic resin in the second solvent in the second mixture when the second mixture is at a certain temperature that is higher than 100° C. and not higher than the boiling point of the second solvent.

23. The method for producing a porous hollow fiber membrane as claimed in claim 21, wherein the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

24. A method for producing a porous hollow fiber membrane comprising a thermoplastic resin, the method comprising:
selecting a first solvent used to perform thermally induced phase separation of the thermoplastic resin;
dissolving the thermoplastic resin in a solvent comprising the selected first solvent; and
performing phase separation of the solution containing the thermoplastic resin dissolved therein,
wherein selecting the first solvent is performed based on a first criterion for determining the first solvent, wherein the first criterion is such that the thermoplastic resin is not uniformly dissolved in the first solvent in a first mixture of the thermoplastic resin and the first solvent at a ratio of 20:80 even when the temperature of the first mixture is raised to the boiling point of the first solvent.

25. The method for producing a porous hollow fiber membrane as claimed in claim 24, further comprising:
selecting a second solvent used to perform thermally induced phase separation of the thermoplastic resin,
wherein selecting the second solvent is performed based on a second criterion, wherein the second criterion is such that the thermoplastic resin is uniformly dissolved in the second solvent in a second mixture of the thermoplastic resin and the second solvent at a ratio of 20:80 when the second mixture is at a certain temperature that is higher than 25° C. and not higher than the boiling point of the second solvent.

26. The method for producing a porous hollow fiber membrane as claimed in claim 25, wherein the second criterion is such that the thermoplastic resin is not uniformly dissolved in the second solvent in the second mixture of the plastic resin and the second solvent at a ratio of 20:80 when the temperature of the second mixture is 25° C., and that the thermoplastic resin is uniformly dissolved in the second solvent when the second mixture is at a certain temperature that is higher than 100° C. and not higher than the boiling point of the second solvent.

27. The method for producing porous hollow fiber membrane as claimed in claim 24, wherein the first solvent is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

28. The method for producing porous hollow fiber membrane as claimed in claim 25, wherein the second solvent is different from the first solvent, and is at least one selected from sebacic acid esters, citric acid esters, acetyl citric acid esters, adipic acid esters, trimellitic acid esters, oleic acid esters, palmitic acid esters, stearic acid esters, phosphoric acid esters, C6-C30 fatty acids, and epoxidized vegetable oils.

29. (canceled)

30. (canceled)

31. A filtration method comprising performing filtration using the porous hollow fiber membrane as claimed in claim 1.

32. The porous hollow fiber membrane as claimed in claim 8, further comprising an inorganic material.

33. A filtration method comprising performing filtration using the porous hollow fiber membrane as claimed in claim 8.
